(19) United States
(12) Patent Application Publication
(10) Pub. No.: US 2008/0000649 A1
(43) Pub. Date: Jan. 3, 2008

(54) Method, system and sprinkler head for fire protection

(75) Inventors: Rasem Guirguis, Peakhurst Heights (AU); Timothy Vasilev, Earlwood (AU)

Correspondence Address: LADAS & PARRY, 26 WEST 61ST STREET, NEW YORK, NY, 10023, US

(73) Assignee: FIRE QUENCH PTY LTD.

(21) Appl. No.: 11/811,350

(22) Filed: Jun. 8, 2007

(30) Foreign Application Priority Data
Jun. 8, 2006 (AU) 2006903126

(51) Int. Cl. A62C 37/10

(52) U.S. Cl. 169/60; 169/37

(57) ABSTRACT

A method for protecting property against fire comprises the steps of: causing a water delivery system to drench at least a portion of the property in response to detection of a fire, detecting arrival of a fire front in proximity of the property (730), and causing the water delivery system to deliver a mist in close proximity to the property in response to detection of the fire front (740). A sprinkler head and a fire protection system for performing the above method are also described.

### TECHNICAL FIELD

The present invention relates generally to fire protection and more particularly to a method and a system for protecting property such as buildings from external fires.

### BACKGROUND

Many commercially available fire protection systems are designed for internal protection of a building and are either manually activated or activated by detection of a fire by means of a sensor in the building. However, external fires such as bush fires are a particular threat in areas on the fringe of bushland and in remote or isolated areas of Australia and other countries. Furthermore, external fires from adjacent buildings and other fire sources in built-up areas also pose a significant danger. Buildings or properties that require fire protection in such circumstances are frequently widely spaced apart. Nevertheless, fires are capable of moving extremely fast, especially when aided by winds.

In external fires such as bush fires, hot embers typically arrive some 30 minutes before the actual fire front. The fire front, when it arrives, comprises a substantial amount of heat energy with temperatures exceeding 1000° C.

Although a limited number of external fire protection systems are commercially available, these systems are subject to certain disadvantages. For example, such fire protection systems generally comprise independent installations that are either manually activated or activated by detection of a fire by means of a sensor located at the building or property. Furthermore, such fire protection systems are not optimized for separately fighting the ember attack and fire front phases of many external fires.

Accordingly, a need exists for improved methods and systems for protecting property such as buildings from external fires.

### SUMMARY

Aspects of the present invention relate to methods and systems for fire protection.

A first aspect of the present invention provides an automated method for protecting property against fire. The method comprises the steps of receiving a remotely activated fire detection signal at the property, causing a water delivery system to drench at least a portion of the property in response to receipt of the remotely activated fire detection signal, detecting arrival of a fire front in proximity of the property, and causing the water delivery system to deliver a mist in close proximity to the property in response to detection of the fire front.

Another aspect of the present invention provides a sprinkler head for use in a fire protection system. The sprinkler head comprises coupling means for coupling the sprinkler head to a means for supplying liquid, a plurality of drenching nozzles for delivering relatively larger droplets of liquid supplied to the sprinkler head via the coupling means, a plurality of misting nozzles for delivering relatively smaller droplets of liquid supplied to the sprinkler head via the coupling means, and a selecting means for selectively controlling delivery of liquid via the plurality of misting nozzles.

A further aspect of the present invention provides a fire protection system comprising a radio frequency unit for receiving a fire detection signal, one or more sensors for detecting environmental parameters, a plurality of sprinkler heads for delivering liquid, and an electronic controller coupled to the radio frequency unit and the one or more sensors. Each of the sprinkler heads comprises coupling means for coupling the sprier head to a means for supplying liquid, a plurality of drenching nozzles for delivering relatively larger droplets of liquid supplied to the sprinkler head via the coupling means, a plurality of misting nozzles for delivering relatively smaller droplets of liquid supplied to the sprinkler head via the coupling means, and a selecting means for selectively controlling delivery of liquid via the plurality of misting nozzles.

The electronic controller is adapted to activate delivery of liquid via the plurality of drenching nozzles in response to receipt of a fire detection signal via the radio frequency unit and activate delivery of liquid via the plurality of misting nozzles in response to detection of arrival of a fire front by the one or more sensors.

### BRIEF DESCRIPTION OF THE DRAWINGS

A small number of embodiments are described hereinafter, by way of example only, with reference to the accompanying drawings in which:

FIG. 1 is a schematic block diagram of a fire protection system spanning multiple installations in accordance with embodiments of the present invention;

FIG. 2 is a schematic block diagram of a fire protection system installed in a to building in accordance with an embodiment of the present invention;

FIG. 3 is an interconnection block diagram of the uninterruptible power supply sub-system of the fire protection system of FIG. 2;

FIG. 4 is a schematic block diagram of the electronic controller of the fire protection system of FIG. 2;

FIG. 5 is a flow diagram of the main software control program for the electronic controller of the fire protection system of FIG. 2;

FIG. 6a is a plan view of a sprier head for use in a fire protection system according to embodiments of the present invention;

FIG. 6b is a sectional front view of the sprinkler head of FIG. 6a taken across a section ‘A-A’; and

FIG. 7 is a flow diagram of an automated method for protecting property against fire according to an embodiment of the present invention.

### DETAILED DESCRIPTION

Embodiments of methods and systems for fire protection are described hereinafter. Certain of the embodiments are described with specific reference to commercial and/or residential buildings. However, it is not intended that the present invention be limited in this manner as the principles of the present invention have general applicability to other types of property or installation, including (without limitation) vehicles (e.g., boats, trucks, etc.), storage containers and farm crops.

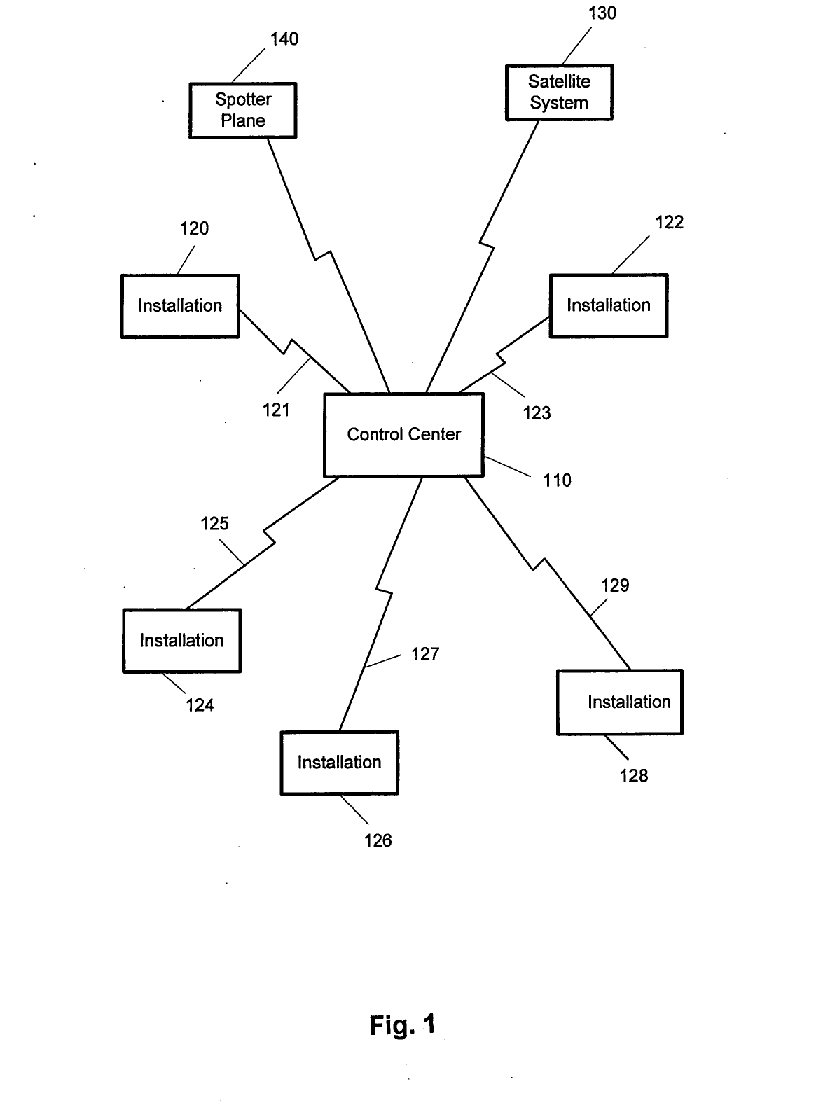

FIG. 1 is a schematic block diagram of a fire protection system spanning multiple installations.

Referring to FIG. 1, installations 120, 122, 124, 126 and 128 may comprise structures such as buildings, infrastructure, vehicles, crops and storage containers. Individual fire protection systems (not shown in FIG. 1, but described hereinafter) are installed at each of the installations 120, 122, 124, 126 and 128 for protecting the respective installations in the event of a fire.

The individual fire protection systems are coupled to a control centre 110 via communications links 121, 123, 125, 127 and 129, respectively, which enable the individual fire protection systems to be remotely activated and/or controlled by the control centre 110 in the event of a fire. Detection of a fire typically occurs by way of a report made to the control centre 110. Such a report may, for example, result from observation of a fire by a person (e.g., via telephone, email or radio) or by a spotter plane 140 or satellite system 130 via a communications link. One such satellite system is the Sentinel Bushfire Monitoring System (also known as Sentinel Hotspots). The Sentinel System is an Internet-based mapping tool designed to provide timely spatial information to emergency services managers across Australia, which may be accessed using a standard web browser. The mapping system enables users to identify fire locations that pose a potential risk to communities, installations and/or property,

The communications is 121, 123, 125, 127 and 129 further enable results of self diagnostic testing performed by the individual fire protection systems to be reported to the control centre 10. This, in turn, enables the individual fire protection systems to be maintained in an operational and standby state in case of an emergency.

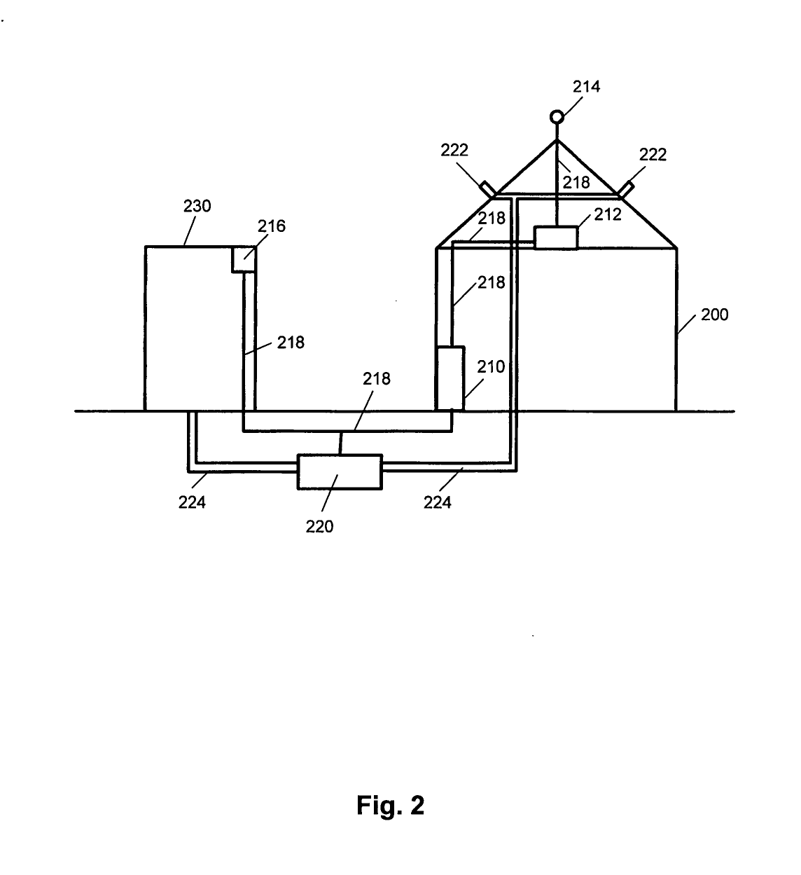

FIG. 2 is a schematic block diagram of a fire protection system installed in a building. For example, the fire protection system of FIG. 2 may be installed at each of the installations in FIG. 1 for fire protection purposes.

Referring to FIG. 2, a water pump 220 is adapted to pump water stored in a water tank 230 to sprinkler heads 222 located on the roof of a building 200 via delivery pipes, when activated. The water pump 220 is preferably located below the minimum level of water in the water tank and may be installed in an underground pit and/or fireproof box to prevent fire damage.

Although the sprinkler heads 222 are shown installed on the roof of the building 200, sprinkler heads may additionally or alternatively be installed in other locations such as on the walls or under the eaves of the building 200. The sprinkler heads should be installed for good water coverage and preferably so that the spray curtains of each sprinkler head overlap to attain complete coverage.

The water tank 230 is preferably of steel construction to withstand heat and of a capacity that is suited to the size of the building 200. The water tank 230 may be fed by gutters or an alternative rainwater harvesting system.

The water pump 220 may be an electric pump and, in certain embodiments, is preferably a self-priming, centrifugal pump and capable of pumping 300 liters per minute at a lifting head of 60 meters. In some embodiments, however, only certain of the foregoing features or capabilities of the water pump 220 may be necessary. Reliability is important and the water pump 220 should generally be capable of enduring long periods of inactivity and yet be able to start and perform without the need for attention from a maintenance person. The water pump 220 may be fitted with a filter to screen unwanted foreign matter from entering the pump.

The water pump 220 is controlled by an electronic controller 210 that is electrically coupled to the water pump 220, an uninterruptible power supply 212 and sensors 214 and 216 via electrical wing 218. The water pump 220 may, for example, be operated at two different speeds to provide two different flow rates and distinct phases of operation (i.e., misting and drenching).

The uninterruptible power supply 212 comprises a battery pack which is sensitive to the elements, particularly heat. For this reason, the uninterruptible power supply 212 should be located indoors, ideally in a cool, dry place. FIG. 2 shows the uninterruptible power supply 212 mounted in the roof cavity of the building 200, which is ideal provided that the temperature in the roof cavity does not routinely exceed about 40° C.

The sensor 214 may comprise an infrared radiation or temperature sensor for detecting the presence of a fire front and the sensor 216 is a water level sensor for detecting an amount of water in the water tank 230. Multiple sensors 214 may be used to detect the presence of a fire front.

The electronic controller 210 comprises a radio transceiver (not shown in FIG. 2) for communicating with a remote control centre (not shown in FIG. 2). In particular, the radio transceiver enables the electronic controller 210 to receive a remotely generated fire detection signal for activating the fire protection system shown in FIG. 2. The radio transceiver further enables the electronic controller 210 to transmit self diagnostics information to the remote control centre. An antenna for the radio transceiver is preferably mounted with the sensor 214 at the highest possible location to minimize any interference.

All components of the fire protection system, including the electrical wiring 218, should be of materials and be installed in a manner to minimize possible fire damage.

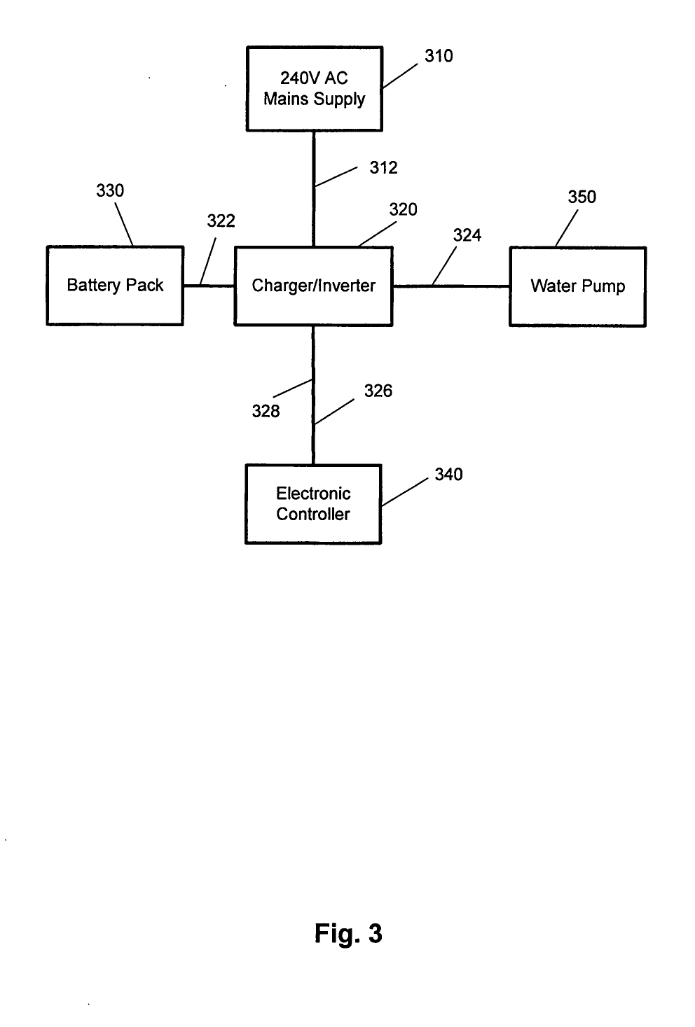

FIG. 3 is an interconnection block diagram of the uninterruptible power supply sub-system of the fire protection system of FIG. 2.

Referring to FIG. 3, the uninterruptible power supply sub-system comprises a charger/inverter 320 and a rechargeable battery pack 330. The charger/inverter 320 is coupled to the mains power supply (e.g., 240V AC) via coupling 312 and is used to charge the battery pack 330 via a low voltage (e.g., 24V DC) coupling 322. The charger/inverter 320 is also used to provide mains power (e.g., 240V AC) to the water pump 350 via coupling 324 and low voltage power (e.g., 24V DC) to the electronic controller 340 via coupling 326. Coupling 328, between the charger/inverter 320 and the electronic controller 340 enables diagnostic information relating to the charger/inverter 320 and battery pack 330 to be relayed to the electronic controller 340.

While mains power is available, the charger/inverter 320 provides mains power for powering the water pump 350, powers the electronic controller 340 and the charger portion of the charger/inverter 320 trickle charges the battery pack 330.

If mains power is interrupted (possibly due to a fire), the charger/inverter 320 uses power from the battery pack 330 to power the electronic controller 340 and the inverter portion of the charger/inverter 320 generates mains power from the battery pack 330 for powering the water pump 350.

The battery pack 330 should be capable of powering the fire protection system in a standby (i.e., non-activated) mode for a specified period of time (e.g., one week) and still have sufficient reserves to power the water pump 350 for a full fire protection event (i.e., activated). Such an event may, for example, be of approximately 3 hours continuous duration.

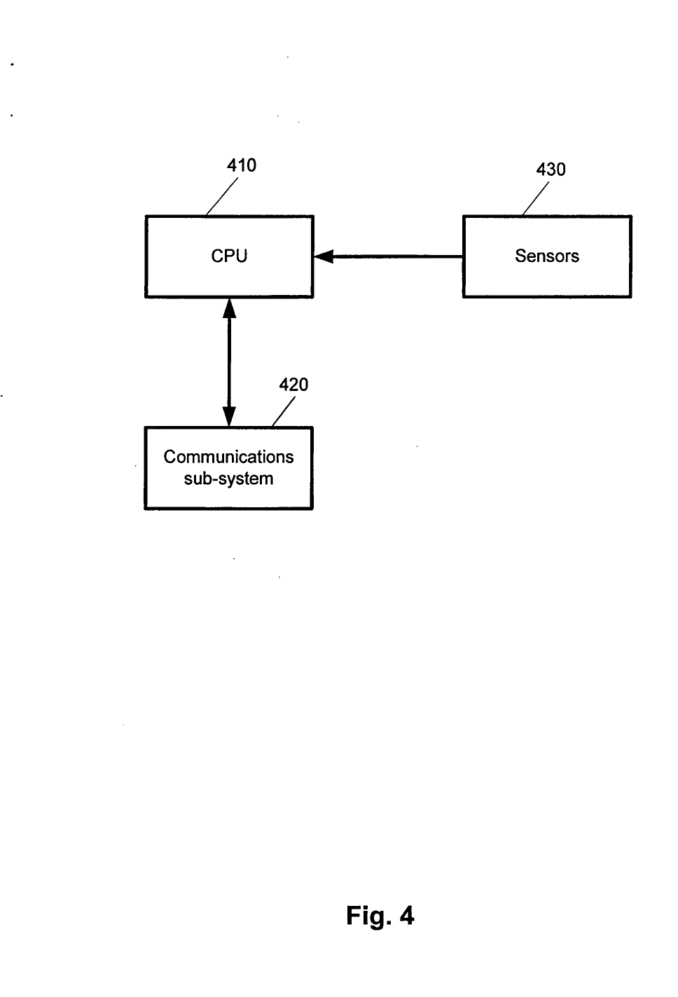

FIG. 4 is a schematic block diagram of the electronic controller of the fire protection system of FIG. 2.

The electronic controller 210 is preferably adapted to:
operate the fire protection system in response to an activation signal;
minimize the use of water subject to prevailing circumstances while the fire protection system is operational; and/or
monitor vital functions and/or components of the fire protection system whether in the activated or non-activated state (i.e., perform self diagnostics) and report any malfunctions to the control centre.

The electronic controller 210 comprises a central processing unit (CPU) 410 coupled to a communications sub-system 420 and one or more sensors 430. The CPU 410 preferably comprises an off-the-shelf embedded computer system or microcontroller, which may have integrated read-only memory (ROM and random access memory (RAM). However, those skilled in the art will appreciate that various alternative computer systems or microcontrollers may be practiced to perform the functions of the CPU 410. An example of such a CPU is a microcontroller available from Freescale Semiconductor <www.freescale.com>.

The communications sub-system 420 comprises a radio frequency unit for receiving commands and optionally reporting diagnostics information to the control centre. The radio frequency unit may comprise a Wireless Access Protocol (WAP) telemetry unit. Those skilled in the art will readily appreciate that numerous alternative communications sub-systems may be practiced, including (without limitation): radio frequency (RF) transceivers such as HF transceivers, VHF transceivers, UHF transceivers, and radio frequency units for operation with wireless networks/standards/protocols such as Wireless Access Protocol (WAP), GSM, CDMA, 3G/UMTS, W-CDMA, WiFi, WiMAX and HSDPA. In a particular embodiment of the present invention, the communications sub-system 420 comprises a Sony Ericsson G28-29 GSM modem coupled to the CPU 410 via a RS-232 communications interface. The GSM modem may be capable of both short message service (SMS) and conventional serial modem communications. A connection to a telephone landline may also be provided.

Various diagnostic tests such as activation of the water pump 220 may be remotely initiated via the communications sub-system 420. In certain embodiments, a receiver only (i.e., without a transmitter) may be practiced to provide the reduced functionality of remote activation without remote diagnostics feedback to the control centre.

The sensors 430 comprise two distinct types. The first type comprises external sensors for detecting characteristics of the environment or atmosphere. Examples of such sensors may include (without limitation):
moisture sensors;
temperature sensors;
humidity sensors;
infrared radiation sensors;
air pressure sensors; and
wind speed sensors.

The temperature and/or infrared radiation sensor/s are of particular importance for determining when a fire front is in close proximity. Detection of a fire front may occur when the ambient temperature and/or level of infrared radiation exceeds a specified level.

Moisture sensors may be deployed in gutters to provide an indication of the moisture content in gutters that may contain leaves. The second type comprises internal sensors for detecting malfunctions in components of the fire protection system. Examples of such sensors may include (without limitation):
water level sensors for monitoring the amount of water available in the water tank (while the system is in the standby mode and the activated operational mode);
voltage and/or current sensors for monitoring the presence or absence of the mains power supply, the power supply to the water pump and the state of the battery pack; and
temperature sensors for monitoring the temperature in equipment enclosures.

For example, a current sensor in the power supply line to the water pump provides an estimate of the water flow rate through the pump and will indicate a jammed pump rotor by virtue of an excessively high current. The tank water level sensor may provide a 3-level output to indicate full/mid/empty levels to facilitate monitoring of available water reserves.

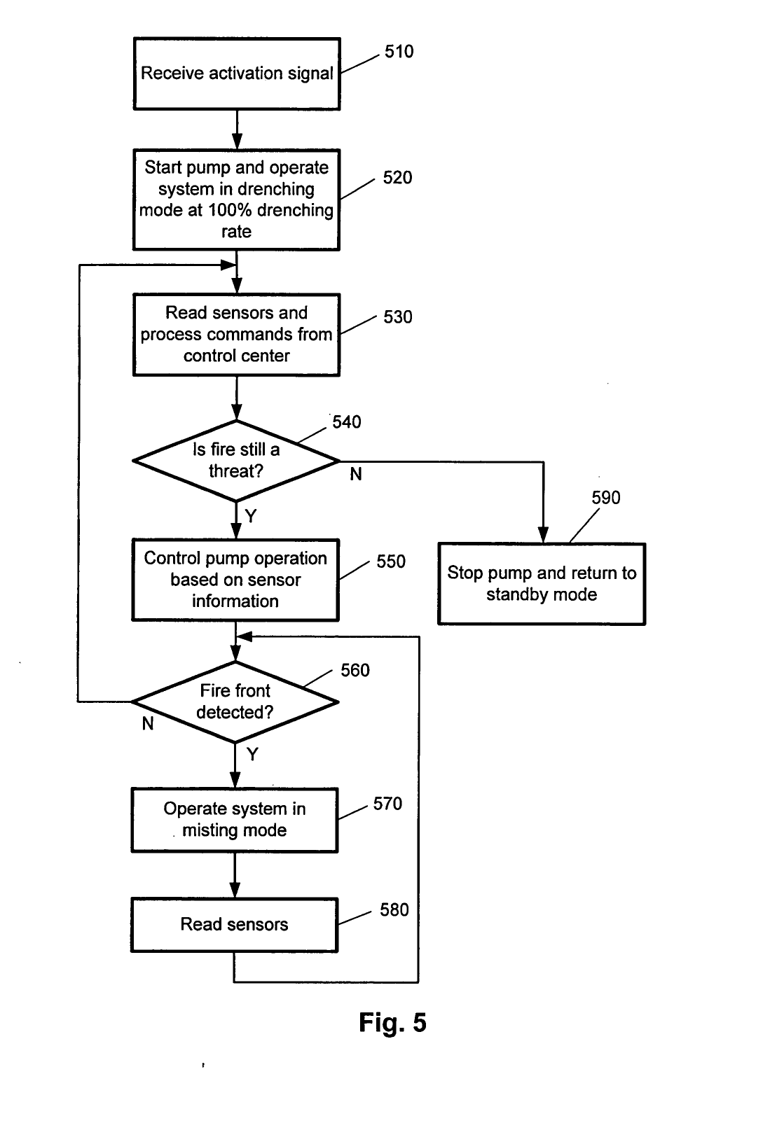

FIG. 5 is a flow diagram of the main software control program for the electronic controller of the fire protection system of FIG. 2.

Referring to FIG. 5, an activation signal is received at step 510. The activation signal may be transmitted from a remote control centre.

At step 520, the water pump is started up and the fire protection system is operated in a drenching mode at a 100% drenching rate. In one embodiment, the system is operated at a 100% drenching rate for a period of 15 minutes or until a deactivation command is received. The drenching mode causes larger water droplets to be delivered, relative to a misting mode (e.g., droplets of Sauter Mean Diameter (SMD) 2,000 to 3,000 microns).

At step 530, the various sensors are read and any information transmitted from the control centre is processed. Such information may include commands and/or data. For example, a command may be received from the control centre to deactivate the pump.

At step 540, a determination is made whether the fire is still a threat based on information obtained from the environmental sensors in step 530 and/or information obtained from the control centre in step 530. For example, detection of a fire front may be performed by the environmental sensors at the property (e.g., temperature and/or infrared radiation sensors), whereas an assessment of the presence of embers in the vicinity of the property may be performed remotely to the property and communicated to the electronic controller via the control centre.

If the fire is no longer a threat (N), the water pump is deactivated and the fire protection system is returned to the standby mode at step 590.

If the fire is still a threat (Y), the pump is activated and de-activated during the drenching mode or phase based on the wetness of the surface/s being drenched, which is determined based on information obtained from the environmental sensors in step 530, at step 550. Surface wetness may be determined by the use of moisture sensors applied to the particular surface.

Alternatively, the system may be operated at an optimal flow rate, which may be determined based on the flow rate required to match the water lost through evaporation. For example, the flow rate should exceed the rate of evaporation in order to maintain a water film over one or more surfaces of the property to prevent embers from starting spot fires in or on the property.

At step 560, a determination is made whether a fire front has been detected (e.g., using one or more temperature or infrared radiation sensor/s). If a fire front has not been detected (N), processing returns to step 530.

If a fire front has been detected (Y), the system is operated in a misting mode at step 570. The misting mode causes smaller water droplets to be delivered, relative to the drenching mode. In one embodiment, droplets of Sauter Mean Diameter (SMD) 100 to 400 microns are delivered in the misting mode. However, those skilled in the art will appreciate that other values and/or ranges of liquid droplet delivery size may be practiced in alternative embodiments. For example, in another particular embodiment, liquid droplets in the range of Sauter Mean Diameter (SMD) 100 to 200 microns are delivered in the misting mode. The misting mode may be switched to from the drenching mode by altering (reducing) the pump speed.

At step 580, the various sensors are read and processing returns to step 560.

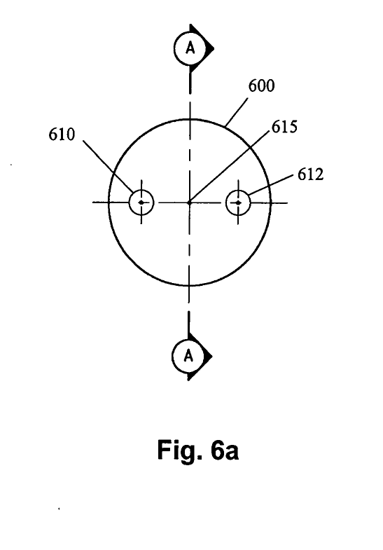

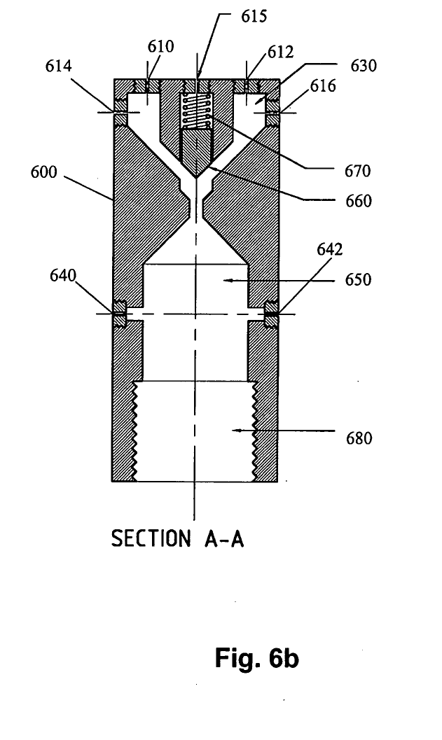

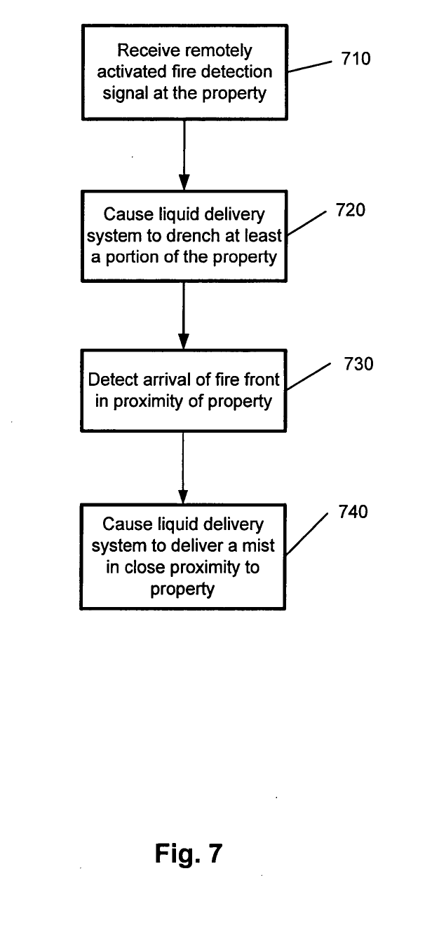

FIGS. 6a and 6b show a plan view and a sectional front view, respectively, of a sprinkler head for use in a fire protection system. In particular, the sprinkler head of FIGS. 6a and 6b may be used in the fire protection systems described hereinbefore with reference to FIGS. 1 to 5 and to perform the method for protecting property against fire as described hereinafter with reference to FIG. 7. The sprinkler head may be of metal construction or of another suitable and sufficiently heat-resistant material.

Referring to FIG. 6a, the sprinkler head 600 is of circular cross section and shows 2 misting nozzles 610 and 612 disposed on a top surface thereof.

Referring to FIG. 6b, misting nozzles 610, 612, 614 and 616 are shown disposed in and fluidly coupled to misting supply chamber 630 and drenching nozzles 640 and 642 are shown disposed in and fluidly coupled to drenching supply chamber 650. Additional misting and drenching nozzles are disposed around the outer circumferential surface of the sprinkler head 600 preferably, but not essentially, at evenly spaced intervals.

An internally threaded connection means 680 enables the sprinkler head 600 to be coupled to a means (not shown) for supplying liquid for delivery by the sprinkler head 600. Those skilled in the relevant art will appreciate that other connection means may be used in place of the internally threaded connection means 680. For example, the connection means may be a press-fit or snap-fit connection means, or any other equivalent connection means known in the art. The means for supplying liquid for delivery by the sprier head 600 may comprise a rigid or flexible pipe, or any other equivalent liquid supply means known in the art.

A needle valve 660 operates in conjunction with a spring 670 to enable or prevent liquid supplied to the sprinkler head 600 to be provided to the, misting supply chamber 630 for delivery by the misting nozzles 610, 612, 614 and 616. The needle valve 660 resides in the closed position under relatively lower liquid supply pressure, thus preventing liquid from being provided to the misting supply chamber 630. When the pressure of liquid supplied to the sprinkler head 600 increases above a specified level, the needle valve 660 opens as the spring 670 compresses, and liquid is supplied to the misting supply chamber 630 and the misting nozzles 610, 612, 614 and 616. FIG. 6b illustrates the needle valve 660 in the open position (i.e., when under pressure above the specified level and with the spring 670 in a compressed state).

The misting nozzles are adapted to deliver liquid (e.g., water) of a relatively smaller droplet size than that delivered by the drenching nozzles. In one particular embodiment, the misting nozzles are designed to deliver liquid droplets of Sauter Mean Diameter (SMD) 100 to 400 microns and the drenching nozzles are designed to deliver liquid droplets of Sauter Mean Diameter (SMD) 2,000 to 3,000 microns. However, those skilled in the art will appreciate that other values and/or ranges of liquid droplet delivery size may be practiced in alternative embodiments. For example, the misting nozzles in another particular embodiment are adapted to deliver liquid droplets in the range of Sauter Mean Diameter (SMD) 100 to 200 microns.

FIG. 7 is a flow diagram of an automated method for protecting property against fire.

Referring to FIG. 7, at step 710, a remotely activated fire detection signal is received at the property. The fire detection signal is typically a radio frequency signal, which may be transmitted from a control centre. In an alternative embodiment, or mode of operation, the presence of a fire may be detected at the property. For example, sensors located at the property may detect the presence of a fire.

At step 720, a liquid delivery system is caused to drench at least a portion of the property in response to receipt of the remotely activated fire detection signal or in response to detection of a fire. Drenching typically causes substantial wetting of at least one surface of the property.

At step 730, arrival of a fire front in proximity of the property is detected. Arrival of the fire front may be automatically detected when infrared radiation in proximity of the property reaches a specified level.

At step 740, the liquid delivery system is caused to deliver a mist in close proximity to the property in response to detection of the fire front. The mist is typically caused in proximity of the property. The liquid is typically water.

The method of FIG. 7 may be practiced in relation to multiple properties or installations using a single control centre, as illustrated in FIG. 1 hereinbefore. Fires may be visually detected (e.g., by a person on land, by way of a spotter plane, or by way of satellite imaging) and reported to the control centre. Upon reaching a decision that a fire represents a real threat to a particular property or installation, a fire protection system installed at that property may be remotely activated from the control centre.

Water reticulation may be used to reduce the amount of water storage required (i.e., tank size) by recycling water collected (e.g., by guttering) during the drenching phase. Since a large volume of water is dispensed during the drenching phase, a significant reduction in storage can be achieved using reticulation.

Similarly, a rain water harvesting system may be used to collect rain water from the gutters. Filters (e.g., flush filters) may be used to trap debris from entering the water tank to prevent blockages in the sprinkler heads.

The foregoing description provides exemplary embodiments only, and is not intended to limit the scope, applicability or configurations of the present invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

We claim:

1. An automated method for protecting property against fire, said method comprising the steps of:
receiving a remotely activated fire detection signal at said property;
causing a liquid delivery system to drench at least a portion of said property in response to receipt of said remotely activated fire detection signal;
detecting arrival of a fire front in proximity of said property; and
causing said liquid delivery system to deliver a mist in close proximity to said property in response to detection of said fire front.

2. A method according to claim 1, wherein said fire detection signal is a radio frequency signal.

3. A method according to claim 1, wherein said drenching causes substantial wetting of at least one surface of said property.

4. A method according to claim 1, wherein said drenching comprises delivery of liquid droplets of Sauter Mean Diameter (SMD) in the range 2,000 to 3,000 microns.

5. A method according to claim 1, wherein arrival of said fire front is automatically detected when ambient temperature in proximity of said property reaches a specified level.

6. A method according to, claim 1, wherein said mist comprises delivery of liquid droplets of Sauter Mean Diameter (SMD) in the range 100 to 400 microns.

7. A method according to claim 1, wherein arrival of said fire front is automatically detected when infrared radiation in proximity of said property reaches a specified level.

8. A method according to claim 1, wherein said property comprises property selected from the group consisting of:
a structure;
a building;
a vehicle; and
a crop.

9. A sprinkler head for use in a fire protection system, said sprinkler head comprising:
coupling means for coupling said sprinkler head to a means for supplying liquid;
a plurality of drenching nozzles for delivering relatively larger droplets of liquid supplied to said sprinkler head via said coupling means;
a plurality of misting nozzles for delivering relatively smaller droplets of liquid supplied to said sprinkler head via said coupling means; and
a selecting means for selectively controlling delivery of liquid via said plurality of misting nozzles.

10. A sprinkler head according to claim 9, wherein said selecting means operates said plurality of misting nozzles based on a pressure of liquid supplied to said sprinkler head.

11. A sprinkler head according to claim 10, wherein:
said drenching nozzles are fluidly coupled to a drenching chamber and said misting nozzles are fluidly coupled to a misting chamber; and
said selecting means comprises a needle valve adapted to control liquid flow into said misting chamber.

12. A sprinkler head according to claim 11, wherein said needle valve is spring-loaded.

13. A sprinkler head according to claim 11, wherein said needle valve enables or prevents liquid flow into said misting chamber.

14. A sprinkler head according to claim 9, wherein said plurality of drenching nozzles are adapted to deliver liquid droplets of Sauter Mean Diameter (SMD) in the range 2,000 to 3,000 microns.

15. A sprinkler head according to claim 9, wherein said plurality of misting nozzles are adapted to deliver liquid droplets of Sauter Mean Diameter (SMD) in the range 100 to 400 microns.

16. A fire protection system, comprising:
a radio frequency unit for receiving a fire detection signal;
one or more sensors for detecting environmental parameters;
is a plurality of sprinkler heads for delivering liquid, each of said sprinkler heads comprising:
coupling means for coupling said sprinkler head to a means for supplying liquid;
a plurality of drenching nozzles for delivering relatively larger droplets of liquid supplied to said sprinkler bead via said coupling means;
a plurality of misting nozzles for delivering relatively smaller droplets of liquid supplied to said sprinkler head via said coupling means; and
a selecting means for selectively controlling delivery of liquid via said plurality of misting nozzles,
an electronic controller coupled to said radio frequency unit and said one or more sensors, said electronic controller adapted to:
activate delivery of liquid via said plurality of drenching nozzles in response to receipt of a fire detection signal via said radio frequency unit; and
activate delivery of liquid via said plurality of misting nozzles in response to detection of arrival of a fire front by said one or more sensors.

17. A fire protection system according to claim 16, wherein said radio frequency unit comprises a GSM modem.

18. A fire protection system according to claim 16, wherein said one or more sensors comprise sensors selected from the group of sensors consisting of:
an inked sensor;
a temperature sensor;
a humidity sensor;
an air pressure sensor; and
a wind speed sensor.

19. A fire protection system according to claim 16, further comprising a pump for electrically coupling to said electronic controller and fluidly coupling to said plurality of sprinkler heads and a supply of liquid; and
wherein said electronic controller is adapted to cause liquid to be delivered to said sprinkler heads at a first pressure in response to receipt of a fire detection signal via said radio frequency unit and at a second pressure in response to detection of arrival of a fire front by said one or more sensors, said second pressure higher than said first pressure.

20. A fire protection system according to claim 16, wherein said plurality of sprinkler heads comprise sprinkler heads according to any one of claims 10 to 15.

21. A fire protection system according to claim 16, wherein said fire detection signal is transmitted by a remote control centre.

22. A fire protection system according to claim 21, wherein said fire detection signal is generated at said remote control centre based on data received from a satellite system.

23. A method according to claim 1, wherein said fire detection signal is transmitted by a remote control centre.

24. A method according to claim 23, wherein said fire detection signal is generated at said remote control centre based on data received from a satellite system.

25. An automated method for protecting property against fire, said method comprising the steps of:
causing a liquid delivery system to drench at least a portion of said property in response to detection of a fire;
detecting arrival of a fire front in proximity of said property; and
causing said liquid delivery system to deliver a mist in close proximity to said property in response to detection of said fire front.

26. A fire protection system, comprising:
one or more sensors for detecting environmental parameters;
a plurality of sprinkler heads for delivering liquid, each of said sprinkler heads comprising:
coupling means for coupling said sprinkler head to a means for supplying liquid;
a plurality of drenching nozzles for delivering relatively larger droplets of liquid supplied to said sprinkler head via said coupling means;
a plurality of misting nozzles for delivering relatively smaller droplets of liquid supplied to said sprinkler head via said coupling means; and
a selecting means for selectively controlling delivery of liquid via said plurality of misting nozzles,
an electronic controller coupled to said one or more sensors, said electronic controller adapted to:
activate delivery of liquid via said plurality of drenching nozzles in response to detection of a fire; and
activate delivery of liquid via said plurality of misting nozzles in response to detection of arrival of a fire front by said one or more sensors.
